(19) United States
(12) Patent Application Publication
(10) Pub. No.: US 2012/0110494 A1
(43) Pub. Date: May 3, 2012

(54) CHARACTER INPUT METHOD USING MULTI-TOUCH AND APPARATUS THEREOF

(75) Inventor: Don Gyo JUN, Gyeongsangbuk-do (KR)

(73) Assignee: SAMSUNG ELECTRONICS CO., LTD., Gyeonggi-Do (KR)

(21) Appl. No.: 13/285,448

(22) Filed: Oct. 31, 2011

(30) Foreign Application Priority Data
Oct. 29, 2010 (KR) 10-2010-0106624

(51) Int. Cl. G06F 3/048

(52) U.S. Cl. 715/773

(57) ABSTRACT

A character input method and apparatus enable a user to input characters rapidly and easily using multi-touch on a touch screen. The character input method using a multi-touch, preferably includes: executing a character input mode; displaying a virtual key pad including a plurality of key regions for character input; generating a multi-touch event on the virtual key pad, the multi-touch event indicating a touch event occurring on at least two key regions; and inputting characters allotted to respective regions according to a touch-released order on a multi-touched key region.

### CLAIM OF PRIORITY

This application claims priority from Korean Patent Application No. 10-2010-0106624 filed in the Korean Intellectual Property Office on Oct. 29, 2010, the contents of which are hereby incorporated by reference in its entirety.

### BACKGROUND OF THE INVENTION

1. Field of the Invention

The present invention relates to a character input method and apparatus for a touchscreen display of an electronic device. More particularly, the present invention relates to a character input method using multi-touch and an apparatus thereof.

2. Description of the Related Art

In recent years, with the significant development of information and communication technology and a semiconductor technology, the supply and use of all types of portable terminals have rapidly increased. In particular, more recent portable terminals have developed toward a mobile convergence stage including a traditional unique field and other terminal fields, as these portable devices do far more than provide telephone service. As a representative example of the portable terminals, a mobile communication terminal provides various functions such as a television (TV) watching function (e.g., mobile broadcasting such as Digital Multimedia Broadcasting (DMB) or Digital Video Broadcasting (DVB)), a music playing function (e.g., MPEG Audio Layer-3 (MP3)), a photographing function, and an Internet access function. In addition, recent portable terminals also typically include a general communication function such as speech call or message transmission/reception.

In recent years, owing to miniaturization and trend to slim the thickness of a mobile terminal, and to improve the convenience of inputting data and commands, the interest of a touch screen has increased dramatically. The touch screen may simultaneously perform functions of an input device and a display device, in some cases on different areas of the touch screen. In a conventional character input method using the touch screen, a virtual key pad including a plurality of key regions is output on a screen, and allotted characters are input on a touched key region. However, since a key region allotted to one character is small because of characteristics of a mobile terminal, it is difficult for a user to exactly input characters. Owing to this difficulty in inputting characters, it is inconvenient for a user to ought to check whether a character is input correctly each time a character is input. Furthermore, in a conventional touch input method, because a user input characters for each individual character, input speed of the characters is often slow.

### SUMMARY OF THE INVENTION

The present invention has been made to provide a character input method using multi-touch that improves the input speed of characters by enabling a simultaneous touch of a plurality of key regions to input the characters, and an apparatus thereof.

The present invention further provides a character input method using multi-touch that may permit multi-touch of a plurality of key regions to check simultaneously or shortly thereafter a predetermined time whether any one of a plurality of touched characters was improperly or incorrectly touch.

In accordance with an exemplary aspect of the present invention, a character input method using a multi-touch, preferably includes: executing a character input mode; displaying a virtual key pad including a plurality of key regions for character input; generating a multi-touch event on the virtual key pad, the multi-touch event indicating a touch event occurring on at least two key regions; and detecting an input of characters allotted to respective regions according to a touch-released order on a multi-touched key region.

In accordance with another exemplary aspect of the present invention, a character input apparatus using a multi-touch, preferably includes: a touch screen enabling multi-touch input, and outputting a character input screen displaying the input of characters through a virtual key pad; and a controller controlling characters allotted to respective key regions to be input according to a touch-released order of multi-touched key regions when a multi-touch event occurs on the virtual key pad, the multi-touch event generating a touch event on at least two key regions.

As illustrated previously, a character input method and apparatus using multi-touch according to an exemplary embodiment of the present invention enabling an input of characters more rapidly and easily than known heretofore using multi-touch. Accordingly, the present invention may improve the convenience of inputting characters in a mobile terminal having a touch screen.

### BRIEF DESCRIPTION OF THE DRAWINGS

The exemplary objects, features and advantages of the present invention will become more apparent from the following detailed description in conjunction with the accompanying drawings, in which:

FIG. 1 is a block diagram illustrating a configuration of a mobile terminal according to an exemplary embodiment of the present invention;

FIG. 2 is a flowchart illustrating exemplary operation of a character input method using multi-touch according to an exemplary embodiment of the present invention;

FIG. 3a and FIG. 3b are flowcharts illustrating exemplary operation of a character input method using multi-touch according to an exemplary embodiment of the present invention in detail;

FIG. 4 is a view illustrating an example of a screen for describing a character input procedure at a simultaneous multi-touch time according to an exemplary embodiment of the present invention;

FIG. 5 is a view illustrating an example of a screen for describing a character input procedure at a sequential multi-touch time according to an exemplary embodiment of the present invention; and

FIG. 6 and FIG. 7 are views illustrating examples of a screen for describing a character input procedure at a combination of a simultaneous multi-touch time and a sequential multi-touch time according to an exemplary embodiment of the present invention.

### DETAILED DESCRIPTION

Exemplary embodiments of the present invention will now be described in greater detail with reference to the accompanying drawings. Typically the same reference numbers are used throughout the drawings to refer to the same or similar parts. Detailed descriptions of well-known functions and structures incorporated herein may be omitted to avoid obscuring appreciation of the subject matter of the present invention by a person of ordinary skill in the art.

The following description of exemplary embodiments of the present invention is provided for illustration purposes only and not for the purpose of limiting the invention as defined by the appended claims. Meanwhile, it should be apparent to those skilled in the art that various changes and modifications of the embodiments described herein based on technical idea of the present invention can be made that are within the spirit of the invention and the scope of the appended claims.

Prior to providing a detailed description of the invention, hereinafter, a mobile communication terminal is described by way of example to disclose the presently claimed invention. However, the presently claimed invention is not limited to mobile communication networks. In other words, the present invention is applicable to various devices having a touch screen capable of recognizing multi-touch. For example, the present invention is applicable to many different devices, including but in no way limited to: a tablet Personnel Computer (PC), a Portable Multimedia Player (PMP), a navigation terminal, a Smart Phone, an Electronic Book, and an electronic dictionary, or devices capable of duplex communication, just to name a few of the possible many types of electronic devices.

As used herein, the term “touch” refers to a state that a touch input device such as a finger of a user or a stylus contacts on a touch panel. The touch may include a single touch in which one region is touched and a multi-touch in which two different regions are touched.

The multi-touch may include a simultaneous multi-touch in which a user simultaneously touches at least two regions and a sequential multi-touch in which a user touches one region and then touches another region without releasing the touch. It is also possible that two portions of a single region can be touched and another region touched simultaneously or sequentially.

As used herein, the term “touch release” refers to releasing contact on a touch panel. The touch release may include simultaneous touch release that a user simultaneously releases all touches in a multi-touch state and sequential touch release that a user sequentially releases at least a part of the touches. The releases may occur within a predefined period of time.

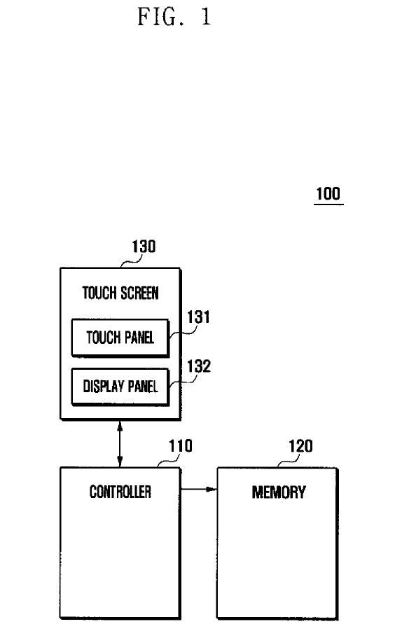

FIG. 1 is a block diagram illustrating an exemplary configuration of a mobile terminal 100 according to an exemplary embodiment of the present invention.

Referring now to FIG. 1, a mobile terminal 100 may preferably include a controller 110, a memory 120, and a touch screen 130.

The touch screen 130 may perform a screen output function and a touch input function. In order to perform both input and output operations, the touch screen may include a touch panel 131 and a display panel 132.

The touch panel 131 is mounted preferably at a front surface of the touch screen 130. If a touch event occurs, the touch panel 131 may detect change of a physical amount (e.g., resistance, capacitance, light block) according thereto to detect the occurrence of the touch event. The touch panel 131 may convert change of a physical amount according to the touch event into a digital signal, and transfer the digital signal to the controller 110. The touch panel 131 may recognize multi-touch.

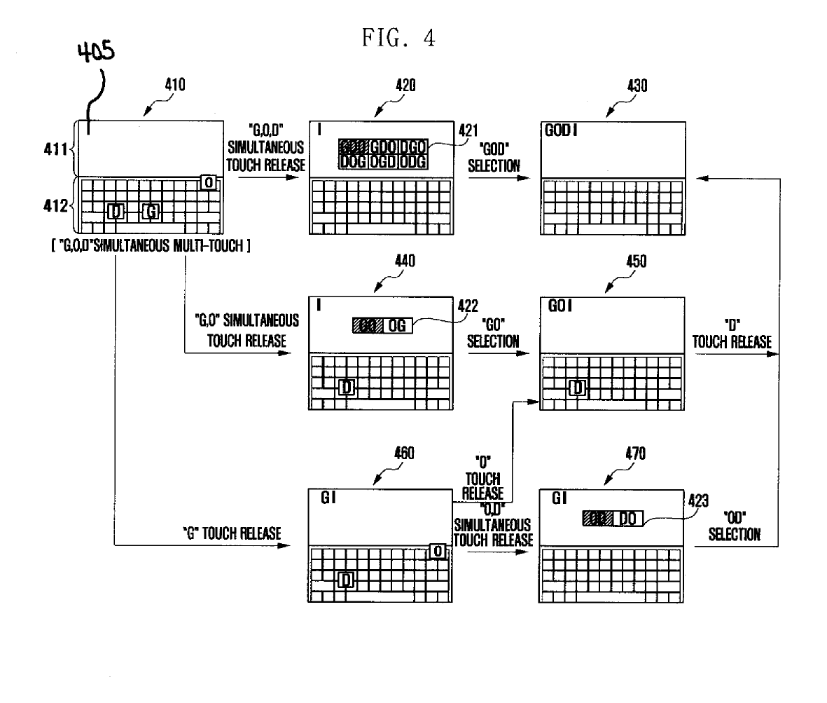

The display panel 132 preferably displays information input by a user or information to be provided to the user as well as various types of menu of the mobile terminal 100. For example, the display panel 132 may provide various screens such as an idle screen, a message making screen, and a call screen according to utilization of the mobile terminal 100. In particular, the display panel 132 according to the present invention may provide a character input screen, such as alpha-numeric characters using multi-touch under the control of the controller 110. A character input screen using the multi-touch will be described with reference to examples of a screen shown in FIG. 4 to FIG. 7 in more detail. The display panel 132 may comprise a Liquid Crystal Display (LCD), an Organic Light Emitted Diode (OLED), or an Active Matrix Organic Light Emitted Diode (AMOLED). Another other thin-film technology may also be used

The memory 120, which can comprise any type of non-transitory memory, and may be either volatile or non-volatile, may store user data as well as programs necessary for a function operation according to an embodiment of the present invention. The memory 120 may chiefly include a program area and a data area. The program area may store a program controlling an overall operation of the mobile terminal 100, an Operating System (OS) booting the mobile terminal 100, an application program necessary for playback of multi-media contents, and application programs necessary for other options function of the mobile terminal 100 such as a camera function, a voice playback function, an image or moving image playback function, and a near distance wireless communication function, and/or associated firmware. In particular, the program area according to the present invention may store a character input program controlling character input using multi-touch.

The data area is an area storing data created according to use of the mobile terminal 100. The data area may store audio data, corresponding contents, information corresponding to user data, and key map information of a virtual key pad. In a particular aspect of the present invention, the data area according may store a dictionary for selecting a combination of suitable characters among a combination of characters allotted to simultaneously multi-touched key regions. The data region may also store character history information that was previously inputted and phrase information. A user may optionally register the phrase information.

With continued reference to FIG. 1, the memory 120 according to the present invention may include a buffer (not shown) for storing a touched order when sequential multi-touch events occur. The buffer may be included in or accessed by the controller 110.

The controller 110, which may comprise a microprocessor, may control an overall operation of the mobile terminal 100 and signal flow between internal blocks of the mobile terminal 100. In particular, the controller 110 according to the present invention may control a character input procedure using multi-touch. In more detail, if a character input mode is activated, the controller 110 may output a character input screen for inputting characters at one side of the touch screen 130. The character input screen may include a character region on which input characters are displayed and a virtual key pad for character input. In this case, it is preferred that the virtual key pad is a Qwerty type in which one character is allotted to one key region. An artisan appreciates and understands that the present invention is not limited to using a QWERTY type virtual key pad.

When a touch and a touch release event occur on one key region of a virtual key pad, the controller 110 may determine that a character allotted to a corresponding key region has been input. Further, the controller 110 checks whether or not a multi-touch occurs. When the multi-touch of the touchscreen occurs, the controller 110 may determine that a character allotted to each key region is input according to a touch-released order of a multi-touched key region. For example, if a touch of a key region allotted to a character “b” is released, a touch of a key region allotted to a character “a” is released, and a touch of a key region allotted to a character “c” is released in a multi-touched state of key regions to which characters “a, b, c” are allotted, the controller 110 may display “bac” on a character region according to a touch-released order. At this time, the multi-touch may preferably include a simultaneous multi-touch simultaneously touching at least two key regions and/or a sequential multi-touch sequentially touching at least two key regions.

When simultaneous touch release occurs in a multi-touched state, the controller 110 may determine that the multi-touch of the touchscreen is a sequential multi-touch. When the multi-touch is the sequential multi-touch, the controller 110 may control characters to be input according to the order in which the screen is touched. For example, when a simultaneous touch-release occurs in a sequential multi-touched state of characters “a”, “b”, “c”, the controller 110 may determine that a character “abc” is input according to a touched order. When the multi-touch sensed by the touch screen is not the sequential multi-touch, that is, when a simultaneous touch is released after a simultaneous multi-touch, the controller 110 may combine characters allotted to respective multi-touch key regions to create character combinations, and display a selection window permitting selection of one of the created character combinations at one side of the character region. The controller 110 may control character combinations selected by a user to be input. When creating the character combinations, the controller 110 may combine characters with reference to a stored dictionary. In other words, the controller 110 may control character combinations registered in a dictionary among character combinations capable of being combined by characters included in respective key regions to be displayed at one side of the character region. The controller 110 may select a character combination displayed on the character region with reference to character history information previously input by a user and phrase information that a user optionally registers. In the case where there is only one character combination capable of being combined (based on a dictionary reference or user-registered term), the controller 110 may omit the character combination display step and control direct input of a character combination.

The foregoing exemplary embodiment has illustrated that a character combination is created and displayed at a simultaneous touch-release time. However, the present invention is not limited to such actions at touch-release time. For example, the controller 110 may display combinations of characters allotted to respective multi-touched key regions when simultaneous multi-touch also occurs. At this time, a user checks the displayed combination characters. In this case, when there are no desired character combinations, or there are too many desired character combinations of a user, the user may release a touch of a key region corresponding to a first character. At this time, the controller 110 may process that a character allotted to a touch-released key region is input and display only a combination of remaining characters.

In the meantime, the foregoing exemplary embodiment has illustrated that a character combination is displayed on one side or portion of the touch screen 130 at a simultaneous touch-release time such that a user can select from among the character combination(s). However, the present invention is not limited thereto. For example, the controller 110 may control a character combination having the (highest probability) highest priority order of character combinations to be input without a separate character combination selection at a simultaneous touch-release.

The mobile terminal 100 according to the present invention may selectively include structural elements for providing many additional functions such as a camera module for taking images or moving images, a broadcasting receiving module for receiving broadcasting, a digital sound source playback module such as an MP3 module, a near distance wireless communication module, and a proximity sensor module for proximity sensing. Since the structural elements can be variously changed according to convergence trend of a digital device, no elements can be listed. However, the portable terminal 100 may include structural elements equivalent to the foregoing structural elements.

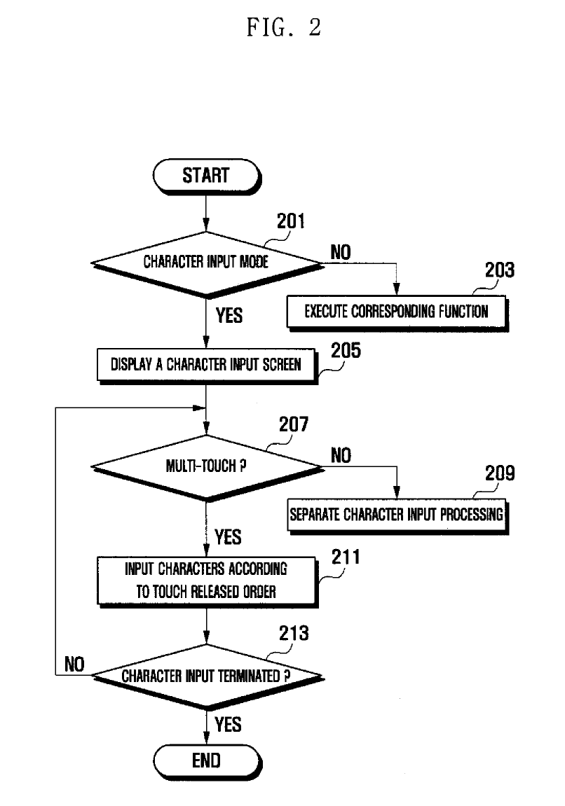

FIG. 2 is a flowchart illustrating exemplary operation of a character input method using multi-touch according to an exemplary embodiment of the present invention.

Referring now to FIG. 1 and FIG. 2, at (201) the controller 110 may determine whether a character input mode is executed. If the character input mode is not executed, then at (203) the controller 110 may execute a corresponding function. For example, the controller 110 may execute a videophone call function, a music playback function, and a digital broadcasting receiving function according to a request of a user. On the other hand, if the character input mode is executed, then at (205), controller 110 may display a character input screen. The character input screen may include a character region on which input characters are displayed and a key pad region on a virtual key pad for character input is displayed. It is preferred that the virtual key pad may be configured by a Qwerty scheme in which one character is allotted to one key region.

Next, at (207) the controller 110 determines whether multi-touch occurs in an output state of the character input screen. The multi-touch refers to a state that a touch occurs on at least two key regions. The multi-touch may include a simultaneous multi-touch simultaneously touching at least two key regions and a sequential multi-touch sequentially touching at least two key regions, as described heretofore. When at (207), the multi-touch does not occur at step 207, when a single touch occurs, then at (209) controller 110 may perform a separate character input processing procedure. For example, when touch-release occurs after touching one key region, the controller 110 may control characters allotted to a touched key region to be input. W hen touch-release occurs after touch movement in a touched state of one key region, the controller 110 may control characters allotted to a touch-released key region to be input.

On the other hand, when at (207) the multi-touch occurs, then at (211) the controller 110 may control characters to be input according to a touch-released order. In other words, a user may sequentially release touches of a corresponding key region among multi-touched key regions according to a character input order.

Next, at (213) the controller 110 may check whether or not character input has terminated. When the character input has not terminated, then at (207) the controller 110 may perform the foregoing procedures. On the other hand, when the character input has terminated character input mode, the controller 110 can terminate display of the character input screen. At this time, although not shown, the controller 110 may further perform a phone number input procedure of a receiving terminal and a procedure for transmitting the input characters to another terminal after termination of the character input mode.

The foregoing embodiment has schematically illustrated a character input method using multi-touch according to an embodiment of the present invention. Hereinafter, a character input method using multi-touch according to an exemplary embodiment of the present invention.

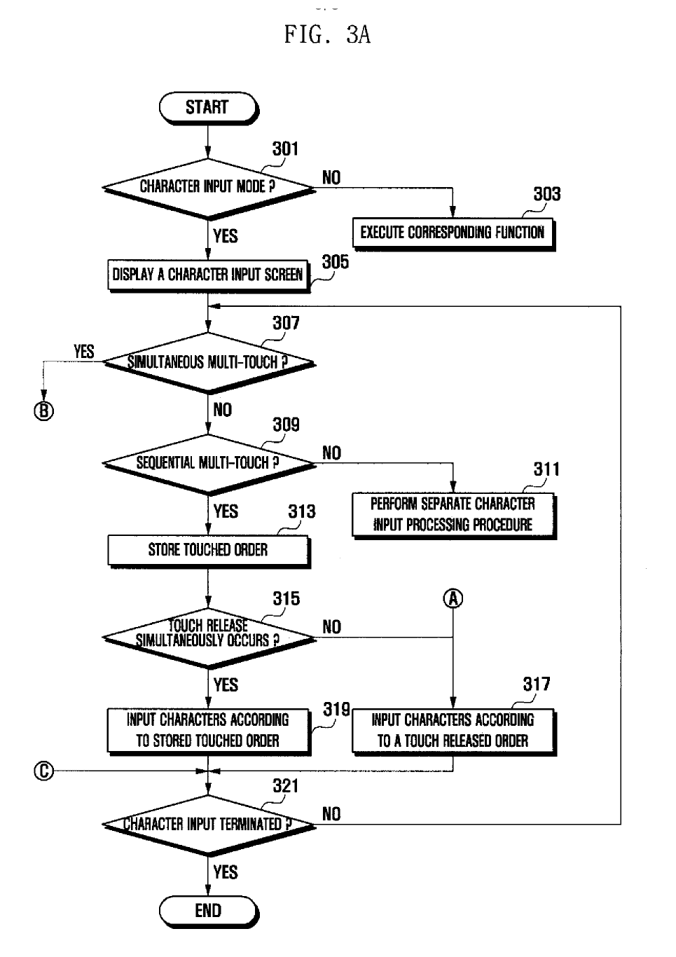

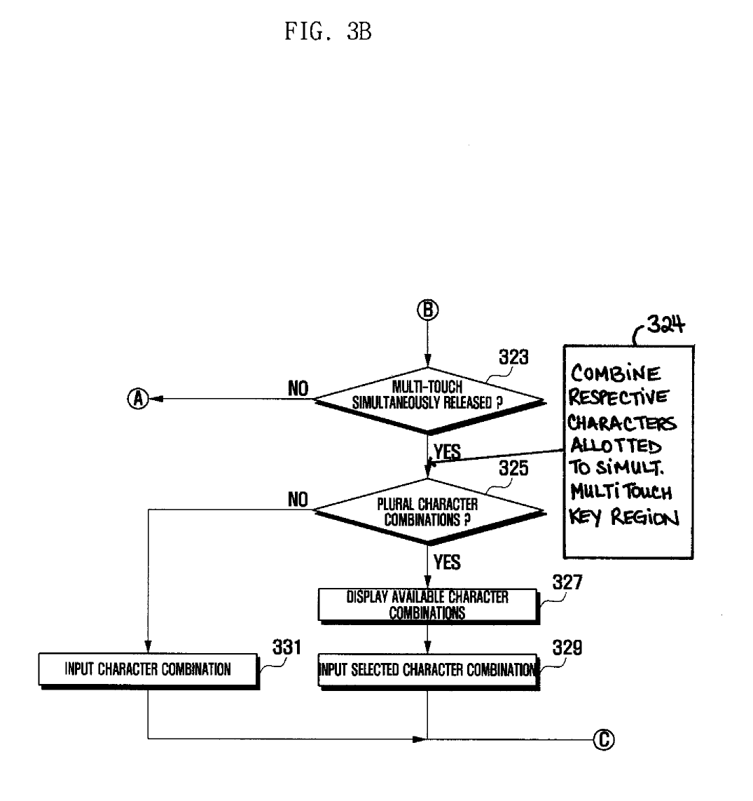

FIG. 3a and FIG. 3b are flowcharts illustrating exemplary operation of a character input method using multi-touch according to an exemplary embodiment of the present invention in more detail.

Referring now to FIG. 1, FIG. 3a, and FIG. 3b, at (301) a controller 110 may determine whether a character input mode is executed. If at (301) the character input mode is not executed, then at (303) the controller 110 may execute a corresponding function. For example, the controller 110 may execute any of a number of different functions, including but not limited in any way to a videophone call function, a music playback function, and a digital broadcasting receiving function, according to a user-request.

On the other hand, if at (301) the character input mode is executed, then at (305) the controller 110 may display a character input screen. The character input screen may preferably include a character region on which input characters are displayed and a key pad region on a virtual key pad for character input is displayed. The virtual key pad may be preferably configured by a Qwerty scheme in which one character is allotted to one key region.

With continued reference to FIGS. 1 and 3a, 3b, at (307) the controller 110 determines whether or not simultaneous multi-touch occurs in an output state of the character input screen. The simultaneous multi-touch preferably refers to multi-touch simultaneously touching at least two key regions as described hereinabove.

At step 307, when the simultaneous multi-touch occurs, then at (323) (see FIG. 3b), controller 110 may determine whether touch-release simultaneously occurs on simultaneous multi-touched key regions. If the touch-release does not occur simultaneously, then at (317) (see FIG. 3a), the controller 110 may perform character input according to a touch order.

On the other hand, with reference to FIG. 3b, when the touch-release simultaneously occurs, at (324) the controller 110 combines respective characters allotted to the simultaneously multi-touched key region. Then at (325), the controller 110 may determine, for example, whether there is a plurality of available character combinations by referring to a dictionary, character history information, database of words and/or phrases, and/or phrase information optionally registered by a user stored in the memory 120. When there is a plurality of available character combinations, at (327) the controller 110 may display available character combinations. Then at (329), the controller 110 may control a character combination selected by a user to be input. On the other hand, when there is not a plurality of available character combinations, or when there is one available character combination, at (331) the controller 110 may input the available character combination.

Referring again to FIG. 3a, on the other hand, when at (307) the simultaneous multi-touch does not occur, then at (309) the controller 110 may determine whether a sequential multi-touch occurs.

When the sequential multi-touch does not occur, in other words, when only a single touch occurs, at (311) the controller 110 may perform a separate character input processing procedure. For example, when the touch-release occurs after touching one key region, the controller 110 may control characters allotted to the touched key region to be input. When the touch-release occurs after a touch is moved to another key region in a state that one key region is touched, the controller 110 may control input of allotted characters to the touch-released key region.

On the other hand, if at (309) the sequential multi-touch occurs at step 309, then at (313) controller 110 may temporarily store a touched order in a buffer (not shown) of the memory 120.

Subsequently, at (315) the controller 110 may determine whether or not touch-release simultaneously occurs on sequential multi-touched key regions.

When at (315) the touch-release does not occur simultaneously, then at (317) the controller 110 may perform character input according to a touch-released order.

On the other hand, when at (315) the touch-release simultaneously occurs, then at (319) controller 110 may input characters according to a touched order stored at step 313.

Next, at (321) the controller 110 determines whether or not a character input is terminated. When the character input is not terminated, the method returns to step 307 and repeats the foregoing procedures. On the other hand, when the character input is terminated, the controller 110 may terminate the character input mode and/or the character input screen. At this time, although not shown in drawings, the controller 110 may further perform a phone number input procedure of a receiving terminal and a procedure transmitting the input or generated characters to another terminal after completing the character input.

Hereinafter, a character input method using multi-touch according to the present invention will now be described with reference to an example of a screen.

FIG. 4 is a view illustrating an example of a screen for describing a character input procedure at a simultaneous multi-touch time according to an exemplary embodiment of the present invention.

Referring now to FIG. 1 and FIG. 4, a user may simultaneously touch a key region to which characters “G”, “O”, “D” are allotted to input a character “GOD” to a character input screen. In this particular case, a controller 110 may enlarge and output at least one character touched by a user as in an example of a screen 410, which may display cursor 405. The controller 110 may determine whether or not a user exactly touches a desired character. However, when an undesirable character is touched, the user may select a described character through touch movement.

Here, the character input screen may preferably include a character region 411 displaying input characters and a key pad region 412 displaying a virtual key pad for inputting characters.

When touches of characters “G, O, D” are simultaneously released in a state of reference numeral 401 (simultaneously multi-touched state of a plurality of characters), the controller 110 combines characters “G”, “O”, “D” to generate combined characters “GOD”, “GDO”, “DGO”, “DOG”, “OGD”, “ODG” as illustrated in an example of a screen, and outputs a selection window 421 permitting selection of any one of the combinations of characters as illustrated in an example of a screen of reference numeral 420. A user may select (e.g., touch) a desired combined character, namely, “GOD” for input from the selection window 421. If the combined character “GOD” is selected (touched), the controller 110 may a screen to which the selected combined character “GOD” is input on a character region 411 as in an example of a screen 430.

Meanwhile, when touches of characters “G, O” are simultaneously released and a touch of a character “D” maintains in a state (simultaneously multi-touched states of a plurality of characters) of reference numeral 410, the touch screen 130 may generate characters “GO”, “OG” combining characters “G”, “O” as in an example of a screen of reference numeral 440 under the control of the controller 110, and may output a selection window 422 permitting selection of any one of the generated combined characters. The user may select (touch) a desired combined character, namely, “GO” for input from the selection window 422. If the combiner character “GO” is selected (touched), the controller 110 may output a screen to which the selected combined character “GO” is input on a character region 411 as illustrated in an example of a screen 450. Subsequently, if a touch of a character “D” is released, the to controller 110 may further input the character “D” to the character region 411 to output a screen to which a character “GOD” is input as in an example of a screen 430.

With continued reference to FIG. 4, when a touch of a character “G” is released but touches of a characters “O”, “D” maintain in a state (simultaneously multi-touched state of a plurality of characters), the touch screen 130 may output a screen to which a character “G” is input on a character region 411 as in an example of a screen 460 under the control of the controller 110. When a touch of a character “O” is released in a state shown by screen 460, the touch screen 130 may output a screen to which a character “GO” is input as in an example of a screen 450. When touches of characters “O”, “D” are simultaneously released in a state by screen 460, the touch screen 130 may output a selection window 423 capable of selecting any one of characters “OD”, “DO” combining characters “O”, “D” as illustrated in an example in screen 470. The user may select (for example, touch) a desired combined character for input from the selection window 423. If the combined character “OD” is selected (touches), the controller 110 may further input the selected combined character “OD” to the character region 411 to output a screen of reference numeral 430 like an example of a screen of reference numeral 430.

As noted above, the user may release a touch according to an order of characters for input in a simultaneously multi-touched state of a plurality of characters or select any one of combined characters after releasing at least two touches to input characters rapidly and easily.

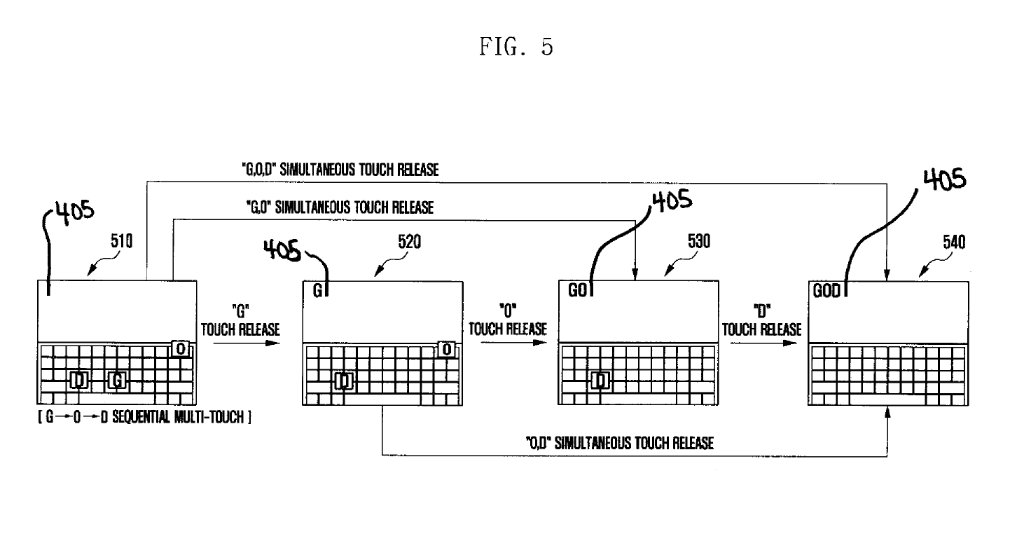

FIG. 5 is a view illustrating an example of a screen for describing a character input procedure at a sequential multi-touch time according to an exemplary embodiment of the present invention.

Referring now to FIG. 1 and FIG. 5, if a user sequentially touches “G”, “O”, “D” for character input, it enters a state shown by the example of a screen 510. When a touch of a character “G” is released but touches of characters “O”, “D” maintain, the controller 110 may input a character “G” as shown in an example by screen 520. Next, when a touch of a character “O” is released but a touch of a character “D” maintains, the controller 110 may further input the character “O” as shown in the example by screen 530.

In the same manner, when a touch of a character “D” is released in a state shown by screen 530, the controller 110 may further input the character “D” as the example shown by screen 540. As described earlier, the controller 110 may input characters according to a touch-released order also in a sequential multi-touch case.

Meanwhile, if touches of “G”, “O” are simultaneously released in a state shown in the example of screen 510, the controller 110 may input a character “GO” according to a touched order input at a multi-touch time to output a screen to which the character “GO” is input as in the example shown in screen 530. If touches of characters “G”, “O”, “D” are simultaneously released in a state shown in screen 510, the controller 110 may sequentially input characters “G”, “O”, “D” according to a touched order input at a multi-touch time to output a screen to which a character “GOD” is input as in the example shown by screen 540.

Further, if touches of the remaining characters “D”, “O” are simultaneously released in a state shown by screen 520, namely, a state to which a character “G” is input, the controller 110 may sequentially input characters “O”, “D” according to a touched order to output a screen to which a character “GOD” is input as in an example of a screen540. As noted above, the user may release a touch according to an order of characters for input in a sequentially multi-touched state of a plurality of characters or release any one of combined characters to input characters rapidly and easily according to a touched order.

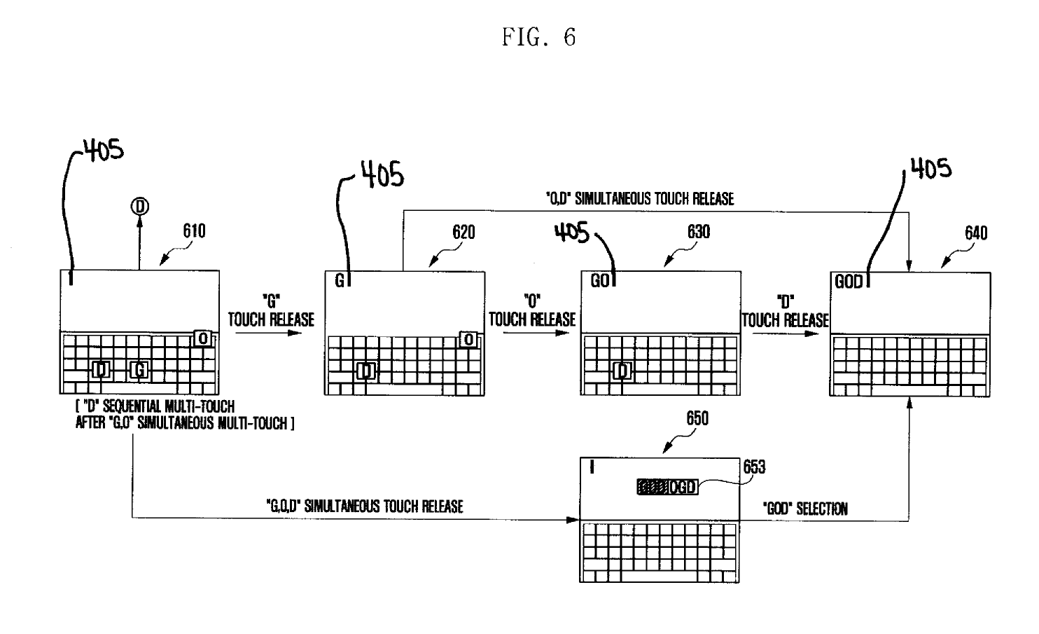

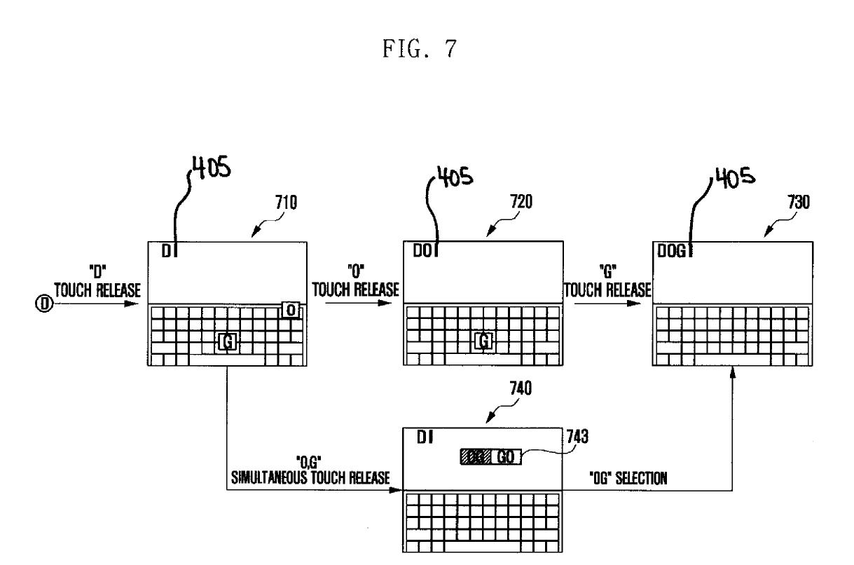

FIG. 6 and FIG. 7 are views illustrating examples of a screen for describing a character input procedure at a combination of a simultaneous multi-touch time and a sequential multi-touch time according to an exemplary embodiment of the present invention.

Referring now to FIG. 6 and FIG. 7, a user may simultaneously multi-touch characters “G, O” on a character input screen for character input and then touch a character “D”. At this time, the controller 110 may enlarge and display a touched character to the predetermined size as in the example shown in screen 610. When a touch of a character “G” is released in a state of an example of a screen of reference numeral 610, a controller 110 may output a screen to which the character “G” is input as shown in exemplary screen 620. Next, when a touch of a character “O” is released, the controller 110 may further input the character “O” to output a screen to which a character “GO” is input as in exemplary screen 630. In the same manner, when a touch of a character “D” is released as screen 630, the controller 110 may further input a character “D” to output a screen to which a character “GOD” is input as in an example shown by screen 640. Meanwhile, when touches of characters “O, D” are simultaneously released in an input state of a character “G” as illustrated in exemplary screen 620, the controller 110 may sequentially input characters “O”, “D” according to a touched order to output a screen to which a character “GOD” is input as shown in exemplary screen 640.

In the meantime, when touches of characters “G, O, D” are simultaneously released in a state shown in an example screen 610, the controller 110 may combine a sequentially multi-touched character “D” with simultaneously multi-touched characters “G, O” to generate combined characters as illustrated in exemplary screen 650 and output a selection window 653 capable of selecting any one of the generated combined characters. At this time, the controller 110 may add a sequentially multi-touched character “D” to a last one of combined characters of simultaneously multi-touched characters “G, O” to generate a combined character. T hat is, the combined characters may be “GOD” or “OGD”. If a combined character “GOD” is selected (touched) by a user in a state shown by exemplary screen 650, the controller 110 may output a screen to which a combined character “GOD” is input as in exemplary screen 640.

If a user releases a touch of a character “D” in a state shown by exemplary screen 610, the controller 110 may output a screen to which the character “D” is input as in an example of a screen of reference numeral 710. As illustrated previously, a touch-released character may preferentially input a touch-released character regardless of a touched order. Next, when a touch of a character “O” is released, the controller 110 may further input a character “O” to output a screen to which a character “DO” is input as shown in exemplary screen 720. In the same manner, when a touch of a character “G” is released in a state of reference numeral 720, the controller 110 may further input a character “G” to output a screen to which a character “DOG” is input as in an example by screen 730. Meanwhile, when touches of characters “O, G” are simultaneously released in an input state of a character “D” as shown in an exemplary screen 710, the controller 110 may combine simultaneously multi-touched characters “O, G” to generate a combined character, and output a selection window 743 permitting selection of any one of the generated combined characters. Subsequently, if a user selects (touches) “OG” from the combined characters, the controller 110 may output a screen to which a previously provided character and a character “OG”, namely, a character “DOG” is input as shown by exemplary screen 730.

Meanwhile, examples of screens shown in FIG. 4 to FIG. 7 illustrate examples of all the character combinations displayed capable of being combined at a simultaneous touch-release time. However, the present invention is not limited thereto. For example, only a suitable character combination may be displayed with reference to a dictionary, word database, character history information, phrase information previously registered by a user.

The above-described methods according to the present invention can be implemented in hardware, firmware or as software or computer code that can be stored in a nontransient recording medium such as a CD ROM, an RAM, a floppy disk, a hard disk, or a magneto-optical disk, thumbnail drive, SD card, SD microcard or MMC card, memory stick or computer code downloaded over a network originally stored on a remote recording medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although a character input method using a multi-touch and an apparatus thereof according to exemplary embodiments of the present invention have been described in detail hereinabove, it should be clearly understood by a person of ordinary skill in the art that many variations and modifications of the basic inventive concepts herein taught may appear to those skilled in the present art, and such variations and modifications will still fall within the spirit and scope of the present invention, as defined by the appended claims.

What is claimed is:

1. A character input method for an electronic device using a multi-touch, said method comprising:
executing by a controller a character input mode that permits character input via a touch screen using multiple touches of the touch screen;
displaying a character input screen comprising virtual key pad having a plurality of key regions for character input;
generating by the controller a multi-touch event on the virtual key pad, the multi-touch event indicating a detected touch event occurs on at least two key regions of the touch screen; and
inputting characters allotted to respective key regions of the touch screen according to a touch-released order on a multi-touched key region.

2. The method of claim 1, wherein the generated multi-touch event comprises: a sequential multi-touch event in which the controller detects sequentially touching of said at least two key regions.

3. The method of claim 1, wherein the generated multi-touch event comprises:
a simultaneous multi-touch event in which the controller detects simultaneously touching of said at least two key regions.

4. The method of claim 2, further comprising inputting characters by the controller according to a touched order stored in memory when the sequential multi-touch event occurs where a touch-release event simultaneously occurs on sequentially multi-touched regions when the sequential multi-touch event occurs.

5. The method of claim 3, further comprising:
generating by the controller and displaying character combinations allotted to respective simultaneous multi-touched key regions when a touch- release event simultaneously occurs on the simultaneous multi-touched key regions when the simultaneous multi-touch event occurs; and
inputting by the controller a character combination selected from the displayed character combinations.

6. The method of claim 3, further comprising displaying character combinations allotted to the simultaneous multi-touched key regions at one area of the touch screen when the simultaneous multi-touch event occurs.

7. The method of claim 6, wherein displaying a character combination at said one area of the touch screen comprises:
inputting characters allotted to a touch-released key region when a touch-release event occurs on one of the simultaneous multi-touched key regions; and
displaying a combination of characters allotted to remaining key regions from among the simultaneous multi-touched key regions.

8. The method of claim 6, wherein displaying a character combination at said one area of the touchscreen comprises displaying a combination of characters registered in at least one electronic compilation in memory selected from the group consisting of an electronically stored dictionary, character history information previously input by a user, a word database, and phrase information optionally registered by the user.

9. The method according to claim 8, wherein the memory storing at least one of said electronically stored dictionary, character history information previously input by a user, a word database, and phrase information is remotely accessed by the controller.

10. The method according to claim 8, wherein the memory storing at least one of said electronically stored dictionary, character history information previously input by a user, a word database, and phrase information is locally accessed by the controller.

11. The method according to claim 7 wherein the touch-release occurs after a touch is moved to another key region in a state that one key region is touched, and wherein the controller controls input of allotted characters to the touch-released key region.

12. A character input apparatus using a multi-touch, comprising:
a touch screen that detects multi-touch input, and outputting a character input screen displaying characters input through a virtual key pad; and
a controller controlling characters allotted to respective key regions to be input for processing according to a touch-released order of multi-touched key regions when it is detected that a multi-touch event occurs on the virtual key pad, the multi-touch event generating a touch event on at least two key regions of the touch screen.

13. The apparatus of claim 12, wherein the detected multi-touch event comprises:
a simultaneous multi-touch event in which simultaneously touching of at least two key regions is detected.

14. The apparatus of claim 12, wherein the detected multi-touch event comprises:
a sequential multi-touch event in which sequentially touching of the at least two key regions is detected.

15. The apparatus of claim 14, wherein the controller controls the input of characters for processing according to a touched order stored when the controller detects the sequential multi-touch event occurs and where a touch-release event simultaneously occurs on sequentially multi-touched regions in a state the sequential multi-touch event occurs.

16. The apparatus of claim 13, wherein the controller generates and displays character combinations allotted to respective simultaneous multi-touched key regions when a touch release event simultaneously occurs on the simultaneous multi-touched key regions in a state that the simultaneous multi-touch event occurs; and controls a character combination selected from the displayed character combinations to be input.

17. The apparatus of claim 13, wherein the controller controls character combinations allotted to the simultaneous multi-touched key regions to be displayed at one area of the touchscreen when the controller detects the simultaneous multi-touch event occurs.

18. The apparatus of claim 17, wherein the controller controls characters allotted to a touch-released key region to be input when a touch release event occurs on one of the simultaneous multi-touched key regions; and controls a combination of characters allotted to remaining key regions to be displayed from among the simultaneous multi-touched key regions.

19. The apparatus of claim 17, wherein the controller controls a combination of characters registered in at least one electronic compilation selected from the group consisting of a stored dictionary, word database, character history information previously input by a user, and phrase information optionally registered by the user for display.

20. The apparatus according to claim 16, wherein the touch-release occurs after a touch is moved to another key region in a state that one key region is touched, and wherein the controller controls input of allotted characters to the touch-released key region.
